(19) United States
(12) Patent Application Publication
(10) Pub. No.: US 2018/0056460 A1
(43) Pub. Date: Mar. 1, 2018

(54) SPRING SEPARATING AND FEEDING DEVICE AND METHOD THEREOF

(71) Applicant: InFocus Industrial System Limited, Kowloon (HK)

(72) Inventor: Ling Keung WONG, Kowloon (HK)

(21) Appl. No.: 15/693,161

(22) Filed: Aug. 31, 2017

(30) Foreign Application Priority Data
Aug. 31, 2016 (HK) 16110369.4

(51) Int. Cl. B23P 19/00

(52) U.S. Cl. CPC B23P 19/005

(57) ABSTRACT

The present invention discloses a spring separation device comprising a silo and a distributor. The silo has a feed hole and the distributor has a discharge hole. One end of the feed pipe is connected with the feed hole and the other end is connected with the discharge hole. The distributor has a needle and a spacer. The needle is located at the proximal end of the discharge hole. The spacer is located at the distal end of the discharge hole. There is an opening on the side wall of the distributor corresponding to the needle and the spacer for the needle and the spacer in and out of the cavity of the distributor. The needle and the spacer are operated simultaneously under linkage mechanism. At the same time, the present invention also discloses a spring separation method. The present invention and the method thereof can quickly and accurately separate and feed the springs, and the structure is simple and easy to use, thereby increasing the production speed and improving the production efficiency.

### FIELD OF INVENTION

The present invention relates to the field of machinery, and in particular relates to a spring separating and feeding device and the method thereof.

### BACKGROUND

In the demand of automatic production, automated feeding, automated assembly and processing are an indispensable and important part for industrial development and manufacturers' development. In the automated production line, there are many products using one or more small springs in the internal structure to achieve specific functions. However, since the springs have a shape that is easily entangled with each other, it is difficult to realize automatic feeding of springs. The present invention aims to solve this problem, and realizes automatic processing of spring separation and feeding, thereby reducing the manpower of hand processing and improving the production efficiency.

### SUMMARY OF INVENTION

In order to overcome the existing problem, the present invention provides a spring separating and feeding device. The present invention is simple and practical, and can quickly and accurately separate the cluttered springs, and distribute the springs to the corresponding product parts, thereby improving the production efficiency and saving time and cost of labor. The present invention provides a spring separating and feeding device, comprising: a silo, a distributor and a feed pipe. The silo has a feed hole and the distributor has a discharge hole. The feed pipe is connected between the feed hole and the discharge hole. The distributor has a needle and a spacer. The needle is located at the proximal end of the discharge hole. The spacer is located at the distal end of the discharge hole. There is an opening on the side wall of the distributor corresponding to the needle and the spacer for the needle and the spacer in and out of the cavity of the distributor. The needle and the spacer are operated simultaneously under linkage mechanism, thereby extending into and extending out the distributor respectively.

In a preferred embodiment, the needle and the spacer are disposed at the same side of the distributor.

In a preferred embodiment, the silo is also provided with a first air inlet and the first air inlet is disposed at a position far away from the feed hole.

In a preferred embodiment, a second air inlet is disposed at a position near the feed hole of the silo.

In a preferred embodiment, the diameter of the feed pipe is 1 to 2 times of the diameter of the spring.

As a preferred embodiment, there is a first detection device outside the feed pipe for detecting the spring motion in the feed pipe.

As a preferred embodiment, the distributor further comprises a discharge pipe which is located at the opposite end of the discharge hole.

As a preferred embodiment, there is a second detection device outside the discharge pipe for detecting the spring motion in the discharge pipe.

As a preferred embodiment, the first detection device or the second detection device is connected with a signal receiving device for receiving signals and controlling the blowing flow rate and the operating rhythm of the needle and the spacer.

As a preferred embodiment, the first or second detection device is further provided with an alarm device.

In another aspect, the present invention is a method for separating springs, comprising: a blowing step for passing compressed air into the silo to blow the gathered springs into individual springs with random movement; a feeding step for feeding the springs into the feed pipe via the feed hole under the action of airflow and towards the distributor; and a distributing step, wherein the springs are separated in the distributor and discharged out one by one.

As a preferred embodiment, the blowing step further comprises simultaneously passing compressed air near the feed hole to assist feeding the springs into the feed pipe.

As a preferred embodiment, the feeding step further comprises: when the foremost spring to be distributed moves into the distributor, the spacer is extended into the distributor and simultaneously the needle is extended out of the distributor, and then the spring moves and stops at the spacer; under control of the linkage device, the spacer is extended out of the distributor and simultaneously the needle is extended into the distributor, and the foremost spring moves towards the discharge pipe, and the later spring is suspended by the needle; the needle and the spacer are respectively extended into and out of the distributor repeatedly, and the springs are separated one by one and moved towards the discharge pipe.

As a preferred embodiment, the method further comprises a detection step for detecting whether spring congestion occurs within the feed pipe and/or the discharge pipe.

As a preferred embodiment, the method further comprises a feedback control step for controlling the blowing flow rate and the operating rhythm of the needle and the spacer according to the result of the detection step or by receiving an external signal.

The present invention and the method thereof can quickly and accurately separate and feed the springs, and the structure is simple and easy to use, thereby increasing the production speed and improving the production efficiency.

### BRIEF DESCRIPTION OF DRAWINGS

FIG. 1 is a schematic diagram of the present invention.

FIG. 2 is a schematic diagram of the present invention in another embodiment.

FIG. 3 is a mounting diagram of the needle and the spacer on the distributor in one embodiment of the present invention.

FIG. 4 is a mounting diagram of the needle and the spacer on the distributor in another embodiment of the present invention.

### DESCRIPTION OF THE PREFERRED EMBODIMENTS

The invention will now be described in further detail with reference to the accompanying drawings.

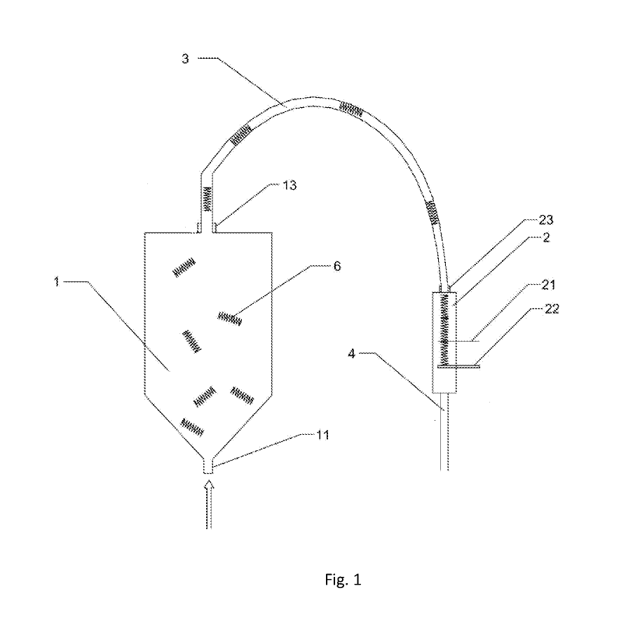

With reference to FIG. 1, in one embodiment of the present invention, the silo 1 is used to store the springs to be separated. The springs 6 pass through the feed pipe 3 connected between the silo 1 and the distributor 2, and finally enter into the distributor 2. The springs 6 are separated and disassembled in the distributor 2, and are automatically distributed to the corresponding components for assembly via the discharge holes 23 of the distributor 2.

The silo 1 is used to store the original springs which are twisted together and stacked in the silo 1. In order to disperse the springs, it is necessary in the present invention to use a high pressure gas stream. Therefore, the silo 1 requires a good sealing performance.

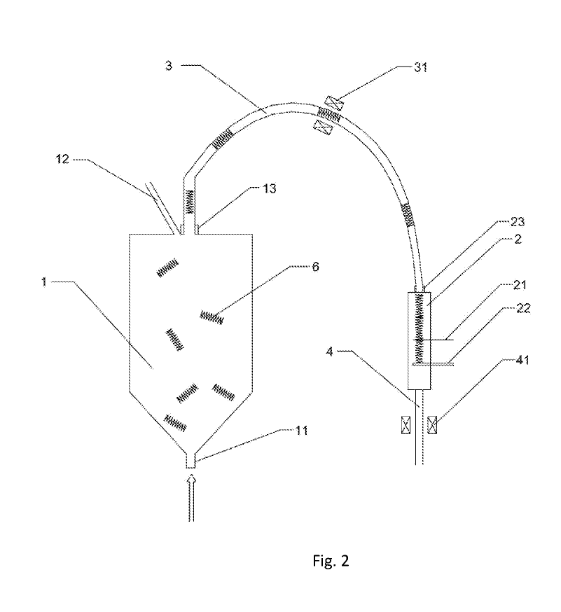

With respect to FIG. 2, in another embodiment of the present invention, the silo 1 has two air inlets: a first air inlet 11 and a second air inlet 12. The first air inlet 11 is used for injecting high pressure air stream to disperse the springs 6. The springs 6 enter into the feed pipe 3 via the feed hole 13. The second air inlet 12 is used to assist feeding the springs 6 into the feed hole 13. The second air inlet 12 can be provided or not based on specific situation.

In a preferred embodiment, the first air inlet 11 and the feed hole 13 are disposed in opposite directions of the silo 1. Using this design, it is advantageous for separating and outputting the springs. The springs are more easily pushed into the feed pipe 3 using the linear injection of high pressure gas stream.

In a preferred embodiment of the present invention, the first air inlet 11 is disposed at the bottom of the silo 1, and the feed hole 13 is disposed at the top of the silo 1. This design prevents the springs 6 from clogging around the feed hole 13, thereby affecting the feeding efficiency of whole system. Under the action of gravity, the springs 6 which do not enter into the feed pipe 3 drop down at the bottom of the silo 1 and are again fed to the feed hole 13 by the high pressure air stream.

The second air inlet 12 can be disposed near the feed hole 13. Moreover, the second air inlet 12 is slightly smaller than the first air inlet 11, for adjusting the springs congested near the feed hole 13.

In order to extend the lifespan of the device and expand the applicability to various types of springs, the two ends of the feed pipe 3 are detachably connected to the feed hole 13 and the discharge hole 23 respectively.

In a preferred embodiment, the diameter of the feed hole 13 can be switched by connecting the reducing joint. When the feed hole 13 is connected to reducing joint, the feed hole 13 can be connected to different feed pipe 3 through different reducing joints. In order to avoid congestion of springs in the feed pipe 3, in general, the diameter of the feed pipe 3 is set to allow one single spring to pass through. That means the diameter of the feed pipe 3 is greater than the diameter of the spring 6 but smaller than double of the diameter of the spring 6. In practical applications, when choosing the feed pipe 3, the diameter of the feed pipe 3 should be slightly larger than the diameter of the spring.

Similarly, the discharge hole 23 at the end of the distributor 2 may be switched using a reducing joint.

In one embodiment, the top of the distributor 2 has a discharge hole 23 for receiving the springs 6. At the bottom of the distributor 2, there is a discharge pipe 4 for the separated springs to slide out one by one. The discharge hole 23 and the discharge pipe 4 are respectively provided at the top and the bottom of the distributor 2. This design makes use of gravity to speed up the spring separation.

On the same side of the distributor 2, a needle 21 and a spacer 22 are provided. The needle 21 is located at the proximal end of the discharge hole 23 and the spacer 22 is located at the distal end of the discharge hole 23. The needle 21 and the spacer 22 are perpendicular to the distributor 2 and penetrate through the cavity of the distributor 2.

When the foremost spring to be distributed moves into the distributor 2, the spacer 22 extends into the distributor 2 while the needle 21 extends out of the distributor 2 and then the spring moves and stops at the spacer 22. Subsequently, under control of the linkage device, the spacer 22 extends out of the cavity of the distributor 2 while the needle 21 extends into the distributor 2. The foremost spring moves towards the discharge pipe 4, and the later spring is suspended by the needle 21.

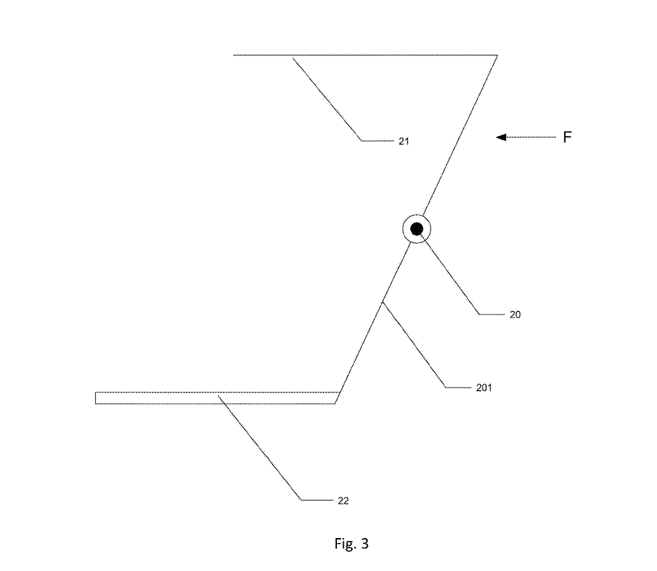

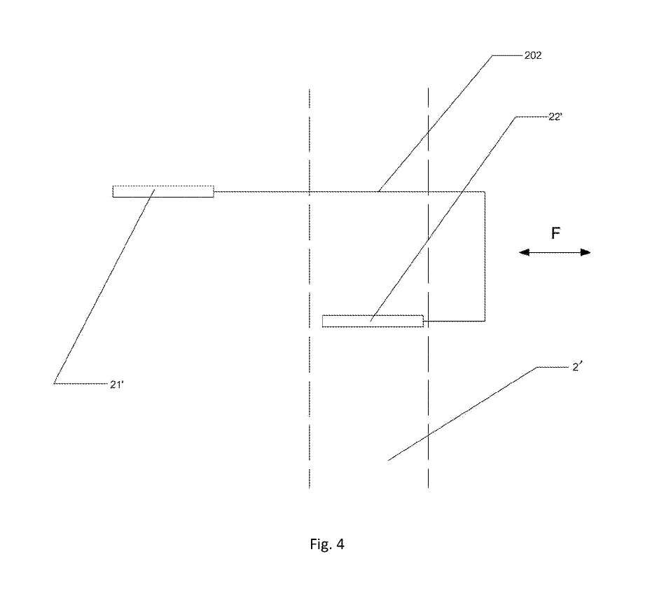

FIGS. 3 and 4 show how the needle 21 and the spacer 22 are installed in different embodiments. As shown in FIG. 3, the needle 21 and the spacer 22 are connected through the connecting rod 201. One end of the connecting rod 201 is connected to one end of the needle 21, and the other end of the connecting rod 201 is connected to one end of the spacer 22. The middle of the connecting rod 201 has a shaft 20 allowing the connecting rod 201 to rotate around it. In this connection manner, the needle 21 and the spacer 22 are disposed on the same outer side of the distributor 2. Under external force, i.e. applying a certain moment at a position of the connecting rod 201 away the shaft 20, the connecting rod 201 is rotated and simultaneously drives the needle 21 and the spacer 22 to move in opposite direction. Therefore the spacer 22 is extended into the distributor 2 while the needle 21 is extended out of the distributor 2, and vice versa.

As shown in FIG. 4, the needle 21 and the spacer 22 are disposed at the opposite sides of the distributor 2 respectively. the needle 21′ and the spacer 22′ are also connected through the connecting rod 202, but are disposed in the horizontal direction on both sides of the distributor 2. The connecting rod 202 performs reciprocating movement in horizontal direction under the action of an external force, and then drives the needle 21 and the spacer 22 to do reciprocating movement in the same direction at the same time. It is also realized that at the same time, when the spacer 22 is extended into the distributor 2, the needle 21 is extended out of the distributor 2, and vice versa.

Accordingly, the needle 21 and the spacer 22 are respectively extended into and out of the distributor 2 repeatedly, and the springs are separated and moved towards the discharge pipe 4 sequentially.

The spring 6 slides into the discharge pipe 4 due to the loss of the support by the action of gravity or air blowing force. In order to ensure that the springs can be accurately separated, there is certain restriction requirement to the positional relationship between the needle 21 and the spacer 22. The vertical height difference between the needle 21 and the spacer 22 should be greater than or equal to one spring's length and less than two springs' length. This setting avoids that two or more springs are separated together. The height difference between the needle 21 and the spacer 22 can be adjusted when needed so as to be suitable for separating springs of various lengths.

With respect to the power source of the needle 21 and the spacer 22, the present invention has a variety of arrangements: in the first aspect, the machinery is driven by a motor to perform reciprocal linkage motion between the needle 21 and the spacer 22; in another aspect, the needle 21 and the spacer 22 are driven by the air flow of the high pressure cylinder and the motor to realize the reciprocal linkage motion between the needle 21 and the spacer 22.

In order to ensure normal operation of the present invention, in the preferred embodiment, the present invention also has a detection device for monitoring the operation of the device.

As shown in FIG. 2, a first detection device 31 is mounted on the outside of the feed pipe 3 and it can perform feedback control to adjust the blowing flow rate of the first air inlet 11 of the silo 1.

When the first detection device 31 detects that there is no spring in the feed pipe 3, the first detection device 31 performs feedback control to increase the pressure of the air flow and thus accelerate pushing the spring into the feed pipe 3.

When the first detection device 31 detects that the springs are accumulated in the feed pipe 3, the first detection device 31 performs feedback control to reduce the pressure of the air flow so as to slow down or pause the pushing of the spring into the feed pipe 3.

At the same time, it is also possible to provide a detection device outside the discharge pipe 4. A second detection device 41 is mounted outside the discharge pipe 4, and the second detection device 41 feeds back the operation rhythm of the needle 21 and the spacer 22.

When the second detection device 41 detects that no spring has passed in the discharge pipe 4, the feedback of the second detection device 41 controls the needle 21 and the spacer 22 to accelerate separation of springs.

When the second detection device 41 detects that there is spring passing through the discharge hole, the feedback of the second detection device 41 controls the needle 21 and the spacer 22 to separate and release the next spring after a certain period of time.

The second detection device 41 can receive external signals and then generate feedback to control the needle 21 and the spacer 22 to separate the springs. Since the spring separation operation on the production line has a high synchronization requirement with the other production steps, control signals can be transmitted to the second detection device 41 through external control terminals according to the demand of actual production speed. When the second detection device 41 receives the signal, it generate feedback quickly to control the operating frequency of the needle 21 and the spacer 22 to adjust the separation speed of springs so that the entire production process is in an efficient and orderly state. In addition, the detection device has an alarm function. When abnormal situation is detected at any one of the two detection devices, the detection device will generate a congestion signal and notify the operator to handle the matter manually when the abnormal situation cannot be solved by multiple feedback adjustment by the device itself.

It should be noted that the above embodiments are used to illustrate the technical solutions of the present invention but not limitation to the present invention. Although the present invention has been described in detail with reference to preferred embodiments, it will be understood by those of ordinary skill in the art that the technical solutions of the present invention may be modified or replaced without departing from the spirit and scope of the present invention. The modification or replacement is within the scope of the claims of the present invention.

What is claimed is:

1. A spring separation device comprising a silo, a distributor and a feed pipe; the silo having a feed hole and the distributor having a discharge hole, the feed pipe being connected between the feed hole and the discharge hole;
wherein the distributor comprises a needle and a spacer; the needle being located at the proximal end of the discharge hole, the spacer being located at the distal end of the discharge hole; there being an opening on the side wall of the distributor corresponding to the needle and the spacer for the needle and the spacer in and out of a cavity of the distributor; the needle and the spacer being operated simultaneously under linkage mechanism, thereby extending into and extending out the distributor respectively.

2. The spring separation device of claim 1, wherein the needle and the spacer are disposed at the same side of the distributor.

3. The spring separation device of claim 1, wherein the silo further comprises a first air inlet and the first air inlet is disposed at a position far away from the feed hole.

4. The spring separation device of claim 1, wherein the silo further comprises a second air inlet disposed at a position near the feed hole.

5. The spring separation device of claim 1, wherein the diameter of the feed pipe is 1 to 2 times of the diameter of the spring.

6. The spring separation device of claim 1, wherein there is a first detection device outside the feed pipe for detecting the spring motion in the feed pipe.

7. The spring separation device of claim 1, wherein the distributor further comprises a discharge pipe which is located at the opposite end of the discharge hole.

8. The spring separation device of claim 7, wherein there is a second detection device outside the discharge pipe for detecting the spring motion in the discharge pipe.

9. The spring separation device of claim 6, wherein the first detection device is connected with a signal receiving device for receiving signals and controlling blowing flow rate and the operating rhythm of the needle and the spacer.

10. The spring separation device of claim 8, wherein the second detection device is connected with a signal receiving device for receiving signals and controlling blowing flow rate and the operating rhythm of the needle and the spacer.

11. The spring separation device of claim 6, wherein the first detection device comprises an alarm device.

12. The spring separation device of claim 8, wherein the second detection device comprises an alarm device.

13. A spring separation method comprising:
a blowing step for passing compressed air into a silo to blow gathered springs into individual springs with random movement;
a feeding step for feeding the springs into a feed pipe via a feed hole under the action of airflow and towards a distributor; and
a distributing step, wherein the springs are separated in the distributor and discharged out one by one.

14. The spring separation method of claim 13, wherein the blowing step further comprises simultaneously passing compressed air near the feed hole to assist feeding the springs into the feed pipe.

15. The spring separation method of claim 13, wherein the feeding step further comprises: when the foremost spring to be distributed moves into the distributor, a spacer is extended into the distributor and simultaneously a needle is extended out of the distributor, and then the spring moves and stops at the spacer; under control of a linkage device, the spacer is extended out of the distributor and simultaneously the needle is extended into the distributor, and the foremost spring moves towards the discharge pipe, and the later spring is suspended by the needle; the needle and the spacer are respectively extended into and out of the distributor repeatedly, and the springs are separated one by one and moved towards the discharge pipe.

16. The spring separation method of claim 13 further comprises a detection step for detecting whether spring congestion occurs within the feed pipe and/or the discharge pipe.

17. The spring separation method of claim 14 further comprises a feedback control step for controlling blowing flow rate and operating rhythm of the needle and the spacer according to a result of the detection step or by receiving an external signal.
